(19) United States
(12) Patent Application Publication
(10) Pub. No.: US 2004/0225537 A1
(43) Pub. Date: Nov. 11, 2004

(54) Method for raising funds

(76) Inventor: James J. Darr, Greenwich, CT (US)

Correspondence Address: PATTON BOGGS LLP, 2550 M Street, NW, Washington, DC, 20037-1350, US

(21) Appl. No.: 10/798,551

(22) Filed: Mar. 12, 2004

Related U.S. Application Data
(63) Continuation-in-part of application No. 10/382,947, filed on Mar. 7, 2003.

(51) Int. Cl. G06F 17/60

(52) U.S. Cl. 705/4; 705/35

(57) ABSTRACT

A method for raising funds includes holding a financial instrument of a first organization in a passive vehicle. The method also includes providing, by a second organization, capital to the first organization as evidenced by a promissory note secured by the financial instrument. The method further includes receiving, by the second organization, a right and/or a benefit that the passive vehicle receives with respect to the financial instrument as repayment of the promissory note.

This is a continuation-in-part of Ser. No. 10/382,947, filed Mar. 7, 2003.

### FIELD OF THE INVENTION

The present invention relates to a fund raising program. More particularly, the present invention relates to a fund raising program for non-profit organizations utilizing life insurance.

### DESCRIPTION OF BACKGROUND INFORMATION

Presently, a need exists to develop and employ programs that offer the potential to raise funds for non-profit organizations (“NPO”), for example, without the NPOs having to ask for more cash and/or capital asset donations from their members.

### BRIEF DESCRIPTION OF THE DRAWINGS

FIG. 1 depicts one exemplary embodiment of a method for raising funds;

FIG. 2 depicts another exemplary embodiment of a method for raising funds; and

FIG. 3 depicts yet another exemplary embodiment of a method for raising funds.

### DETAILED DESCRIPTION

One embodiment of the present invention provides a program that may include a structured financial transaction. The structured transaction may include several components and each of the components has value. The program may ensure the financial viability of one or more non-profit organizations including, for example, educational, religious, and/or charitable organizations.

The program may provide benefits from mortality distributions that may not be obtained without ownership of insurable interests. Insurable interests may trigger the cash flows and the duration of the structured financial asset, as well as create a ratable and more secure component value to part of the asset depending upon the rating of the underlying insurance company. Institutions (e.g., buyers, lenders, individuals, etc.) may not manufacture or acquire insurable interests for the purpose of insuring them. An organization such as, for example, an NPO, with defined legal rights to an insurable interest in an individual can undertake to insure them.

The program may create the aggregation, for example, of large numbers of life risks. The program may provide benefits to the NPO, for example, through the transfer of the cash flows resulting from the mortality rate of the aggregated insured interests and/or the underling investment performance and/or guarantees that may exist within an insurance policy(ies). Under the program, the NPO may accelerate receipt of future cash flow benefits from the aggregated insured interests by transferring, for example, through sale, use, control, assignment, and/or license, the future cash flow benefits and/or other rights and benefits, in whole or in part, to buyers (e.g., third-party and/or affiliated buyers) and/or lenders. The program allows the NPO to realize, at least, in whole or in part, a projected present value of its future cash flow benefits.

In order to participate in the program, institutions may do so from an owner legally entitled to the insurable interests such as, for example, NPOs. The valuation of the program may be based upon the program's ability to meet the institutions' needs and their valuation of each of its components.

Under the program, insurable interests may give consent to a NPO to allow themselves to be individually insured by the NPO, for example, for approximately $250,000.00 each. The insurable interests may include individuals associated with the NPO such as, for example, donors, employees, members, parishioners and/or friends of the NPO. The insurable interests may also include the category of individuals in whom the participating NPO has an interest, for example, under the Internal Revenue Code (“IRC”) and/or state code.

The insurer may be an offshore and/or domestic company and the closing of the policy(ies) may occur offshore and/or domestically. The definition of insurable interests may include that of the jurisdiction of closing such as, for example, Bermuda.

The insureds may agree to permit the NPO to take out the policy(ies) on their lives with the NPO named as the beneficiary. The insureds may irrevocably gift this right and the benefits associated with it to the NPO. Premiums may then be the sole responsibility of the NPO. The insureds may also grant the NPO, for example, the right to transfer (e.g., sell, use, control, assign, and/or license) the policy(ies), a net cash flow from the policy(ies), and/or other rights and/or benefits at the NPO's discretion. Over the term of the policy(ies) (e.g., approx. 60 years), the policy(ies) produces cash flow from death benefits and additional earnings dependant upon its structure. The policies may be aggregated into a group covering, for example, a minimum of 1,000 lives. Premiums on the policy(ies) may be paid by the NPO. The insureds may have no obligations for any of the premium payments on their policy.

Under the program, the NPO may provide, for example, through a sale, the net cash flow benefits of the policy and/or the policies to one or more institutions. The buyer may provide the funding for the premium payments and/or additional payment to the NPO. The buyer of the cash flow benefits may also have additional rights that may provide, for example, facilities for borrowing, cancellation of the policy(ies) and/or distribution of funds, and/or the right to sell and/or assign all or part of the policy(ies). The NPO may have no obligation to make premium payments in order to keep the policy(ies) in force.

The buyer may purchase the policy(ies) at an internal rate of return and/or present value. The policy(ies) may be structured as fully qualified life insurance and/or any other type of life insurance. The proceeds from the sale may include the payment of premiums, for example, for year one and the present valued contribution to the NPO, and a guarantee of payment of premiums, for example, for year two. Following the initial premium payments, which may cover all premiums for the first five years (or more or less), the periodic death benefits and additional pro rata earnings may be first applied to the payment of premiums due. The remaining amount may form the basis for annual net cash flows paid to the buyer. The sale may also provide for the payment of premiums for year one and a guarantee of premium payments for a predetermined number of years.

The policy(ies) may also be structured as a Modified Endowment Contract (“MEC”). The proceeds from the sale may include the single first year premium and the present valued contribution to the NPO. Following the single premium payment, the periodic death benefits and additional pro rata earnings may form the basis for annual cash flows paid to the buyer.

The NPO may also provide the funding for the initial insurance premiums, in whole or in part, including binders for the purchase of the policy(ies), for example, from its own funds (e.g., capital, loans, gifts, etc.).

The Program may spread income (e.g., net of insurance premiums and expenses) to the owner/beneficiary(ies) of the policy(ies), for example, in annual installments over approximately sixty years (or more or less). Net cash flow after payment of the premiums to the owner/beneficiary may be lower, for example, in the first 25-30 years and higher in the last 30-35 years dependant upon, for example, the age of the insureds, their mortality rate, and/or the investment performance of the separate account and/or guarantees of the insurance company.

The NPO may choose to hold the policy(ies) and collect the income stream from the policy(ies) death benefits and earnings, for example, over the approximate sixty-year term. The NPO may also choose to accelerate receipt of the cash flow benefits from the policy(ies) by transferring (e.g., selling) the cash flow benefits and/or other benefits to one or more buyers (e.g., an institutional buyer) and/or lenders.

If the NPO elects to sell the cash flow benefits, the sale price of the policy(ies) may be based upon the internal rate of return (“IRR”) and/or present value of the policy(ies)'s cash flow benefits, for example, over the approximate sixty years as determined by the buyer. The proceeds from the sale of the policy(ies) may be used to pay fees and expenses and/or the NPO. The sale price may be determined by the interest rates and other market conditions prevailing at the time the policy(ies) are sold.

Another embodiment of a fund raising program, for example, for non-profit organizations (“NPO”) also utilizes an insurance policy(ies).

A first organization may license the program to selected NPOs. Under the Program, donors, employees, members, parishioners and/or friends of NPOs (e.g., “Insureds” who fall under the category of ‘insurable interests’ under applicable law) allow themselves to be individually insured, for example, for $250,000 (or more or less) each by the NPO. The Insureds agree to permit the respective NPO to take out a life insurance policy on their lives and dispose of it in whole or in part as the NPO deems appropriate. The insureds may irrevocably assign these rights and the benefits associated with them to the NPO. The policy(ies) may be issued by an investment grade rated insurance company. Premiums may be the sole responsibility of the NPO.

The policy(ies) may be structured as a fully qualified life insurance policy with a single premium, e.g., a Modified Endowment Contract (“MEC”). As owner, the NPO may borrow against and/or transfer (e.g., sell, assign) the policy(ies) or the net cash flow benefits at its discretion. Over the term of the policy (e.g., approximately 60 years), cash flow may be generated from total death benefits. The NPO may bind the policy(ies) with its own funds.

Simultaneously with the completion of the program at the NPO level or thereafter, the NPO may engage a registered broker/dealer (the “placement agent”). The placement agent may offer a promissory note (the “note”) to an investor who meets certain qualifications (the “lender”).

The lender may lend funds to the NPO on a non-recourse basis, evidenced by the note, which may be secured by the policy(ies). The NPO may use a portion of such funds to pay the policy(ies) premium. The NPO may use the balance of the funds to pay its expenses associated with the program and may retain any remaining amounts. The note may bear interest at a negotiated rate, compounded annually, and may have yield maintenance provisions entitling the lender to an internal rate of return (e.g., eighteen percent (18%)). The note may be secured solely by the policy(ies). The note may be payable solely from the death benefits. All of the death benefits may be used to pay principal and interest on the note until the note has been repaid in full.

After acquisition of the policy(ies) by the NPO, the NPO may contribute the policy(ies) to a trust, for example, meeting, under current accounting literature, the requirements of a Qualifying Special Purpose Entity (“QSPE”). The periodic death benefits and additional earnings from the policy(ies) may form the basis for annual cash flows paid to the lender from the trust. The trust may be passive and may collect and forward death benefits, acting, for example, as a pass-through entity.

Upon the NPO's transfer of the policy(ies) to a trust, the lender may have an investment classified as an “available for sale investment” under FASB 140 at the lender's full purchase price. FASB 140, issued September 2000, is effective for transfers and servicing of financial assets and extinguishments of liabilities occurring after Mar. 31, 2001 and for disclosures relating to securitization transactions and collateral for fiscal years after Dec. 15, 2000.

The lender may also have a call option to acquire the policy(ies) from the trust (the “Option”). The lender can exercise the Option at any time by giving notice to the trustee of the trust. The strike price of the Option may the original issue price of the note reduced by the outstanding principal balance plus any accrued but unpaid interest on the note. The lender may also have the right to sell or assign all or part of the loan at its discretion. The policy(ies) may remain in force with no additional premium as long as there is sufficient cash value within the separate account to cover the charges under the insurance policy.

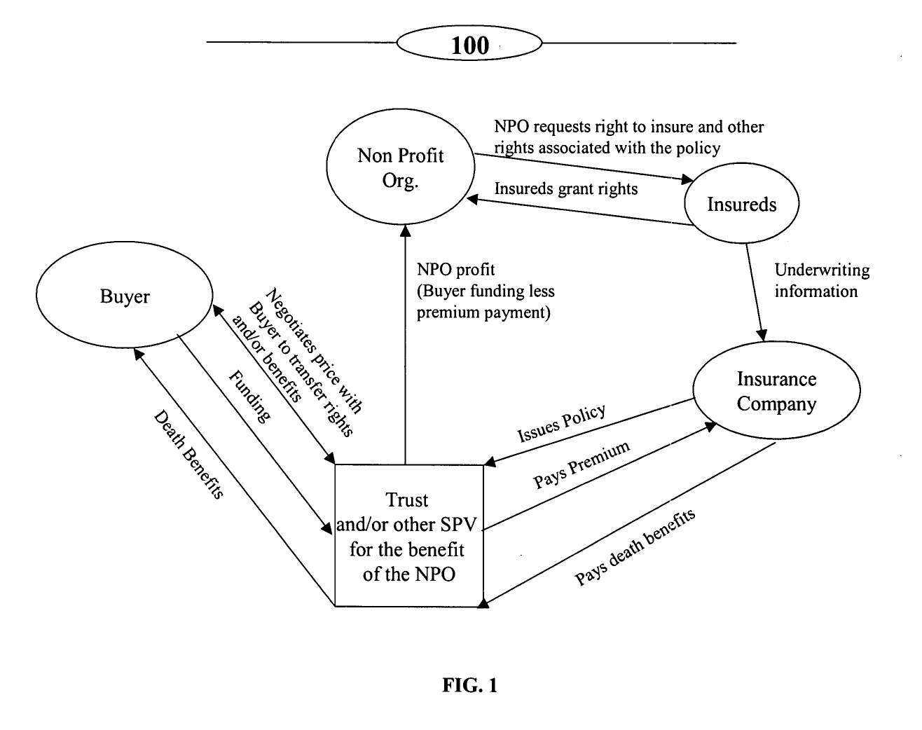

The acts to implement one exemplary embodiment of the program (see, for example, FIGS. 1 and/or 2) may include:

Identification of qualified insureds in a NPO;

Requesting the insureds to enroll in the program;

Completion by the insureds of an application that provides information pertinent to the ability of the insurance company to underwrite the insurance policy and permits the NPO to take out a policy(ies) naming itself as beneficiary and granting it the irrevocable right to utilize the policy(ies) as it determines would be in its best interests;

Selecting insureds, for example, in groups of 1,000 (or more or less), for example, who meet a standard of good health, distribution of ages, etc. (e.g., from an actuarial matrix and/or formula);

Payment of premiums, in whole or in part (e.g., the initial premiums), including binders for the purchase of the policy(ies), for example, by the NPO from its own funds and/or through financing arranged with one or more institutions;

Transfer (e.g., sale) of the cash flows, other rights and benefits and/or the policy(ies); and/or

Payment to the NPO of the difference between the transfer (e.g., sale) price of the policy(ies) and the initial premium or premiums, less fees and expenses.

The program may be divided into one or more parts such as:

1. Insurance Policy(ies);

2. Institutional Funding of the Policy(ies); and/or

3. NPO Marketing.

Insurance Policy(ies):

The program may include the MEC, the two year program and/or any other structured insurance policy (e.g., any type of structure life insurance policy such as, for example, an individual and/or group policy), whether Variable Universal Life, which utilizes the separate account, or a standard guaranteed policy where the insurance company holds the money in its General Account. Whatever the structure of the policy, the program may apply a process (see, for example, FIG. 1) to realize a gain for the NPO.

A NPO may take out a life insurance policy(ies) on its employees, contributors, etc., that qualify as insurable interests. Each individual may be insured for a minimum of approximately $250,000. The individual policies may be aggregated into a group of 1000 lives (or more or less) that match an actuarial matrix/formula that provides the necessary expected mortality rate to give the institutional investors a predictable return. The policy(ies) may then be closed, aggregated into the groups of 1000 (or more or less), and also payment may be deferred for up to approximately 60 days (or more or less) to allow for the institutional funding to take place.

The policy(ies) may qualify as an insurance contract. It may be a variable universal life policy with annual premiums (“AP”) and/or a MEC with a single premium utilizing a separate account structure. The insurance company may guarantee death benefits so long as the policy(ies) remains in force. Death benefits may increase and/or decrease with the value of assets in the separate account.

The insurance companies may select money managers with suitable track records. The institutional buyer may have an input into the selection of the money managers investing the funds in the separate account. The policy(ies) may also utilize any other well-known account structure.

In an embodiment including the AP structure, premiums may be paid-in the first and second year (and/or other years). The first and second year premiums may be increased to the maximum amount allowed under Section 7702 of the IRC for a seven year pay in. No premium payments may then be made until year six (and/or any other year). At that time, death benefits may cover all premiums due plus provide positive cash flow until the termination of the Program, for example, in the 60^{th} year. Premiums under the variable policy may be subject to change according to investment experience within the policy.

The institutional funding may accommodate the two year premium pay-in. The buyer may pay in the total of the first year premium plus the present value spread and provide a guarantee for the second year premium.

In an embodiment including the MEC structure, the single premium may be the maximum amount allowed under Section 7702 of the IRC. The premium may be due at closing. This may be done through a trust vehicle.

The policy(ies) may remain in force with no additional premium so long as there is sufficient cash value within the policy(ies) to pay the expenses of the policy(ies).

Death benefits may consist of the standard death benefit (e.g., $250,000 (or more or less)). Total Death Benefits may be the standard death benefit (less any premium payments if applicable) plus the allocable portion of additional cash value. Death benefits may be greater than $250,000, for example, if investment performance is sufficiently positive.

The insurance company may assume responsibility for mortality tracking and/or other policy(ies) administration.

Institutional Funding:

The institution may acquire the net cash flows from the policy(ies) at an internal rate of return (“IRR”) and/or net present value (“NPV”) acceptable to the NPO and the institution. Total death benefits may be used to calculate this number, as well as other features and benefits that weigh in the value of the asset class of the program the institution(s) assign to ownership. These include:

A transfer (e.g., a sale such as, for example, an assignment) for the net cash flows and/or certain rights and/or benefits and, for example, not a security under the '33 Act, and/or, if a security, may then be an unregistered security and/or a registered security;

May be booked as “other asset” and income booked as “other income”;

May be accounted for each year with a determined accrual;

May not be “marked-to-market”;

May be non-callable since the insurance policy(ies) may be non-callable;

Certain policy loan provisions, which rights can be enforced by the institutional buyer, allow for additional asset leverage;

The net cash flow and/or certain rights and benefits may be sold (e.g., assigned) to subsequent holders; and/or

An aftermarket may be developed.

Presently, a shortage of long-term rated income vehicles exists in the marketplace. Institutions requiring long-term income and asset diversification (such as, for example, pension funds, insurance companies, bond funds, banks, etc.) may be candidates for this product.

The institution may also choose to purchase the entire holding vehicle (e.g., trust) inclusive of the policy(ies). This may entail the issuance of a security by the NPO. Non-Profit Organization Marketing:

The NPO may identify the qualified insureds, and contact (e.g., in conjunction with a third party) the insureds requesting them to permit the NPO to insure them. The insureds may fill out a form (e.g., a confidential short form) authorizing the NPO to take out the policy and name itself (or its assigns, e.g., the trust) the owner/beneficiary. The approval of the insureds may be irrevocable and permit the NPO to dispose of, hypothecate or otherwise utilize the policy or its benefits. The insureds may have no obligation and/or responsibilities for premium payments.

The insurance company may select individual insureds, for example, in groups of approximately 1,000 or more, to match an actuarial matrix/formula for each policy(ies). The insurance company may form the policy and/or group of policies in contemplation of closing, for example, within 60 days. The policy(ies) may be held in a trust and/or other special purpose vehicle, for example, that may be bankruptcy remote.

The net cash flow and/or other rights and/or benefits from the policy(ies) due to the NPO may be transferred (e.g., sold) on an exclusive best efforts basis. Net cash flow may be the yearly death benefits minus the annual premium due if any. The difference between the sale price of the cash flows and/or other rights of the policy(ies) and the initial premiums may be paid to the NPO. The NPO may pay fees and expenses.

### Exemplary Features and Benefits

The program may include any and all types of insurance policies. The program may also include an offshore and/or a domestic carrier. In addition, the program may provide for the transfer, partially, exclusively, and/or wholly, of cash flows. The program, however, is not limited to that structure. The program may provide for the transfer, partially, exclusively, and/or wholly, of any and all rights and/or benefits in whatever form.

### One Embodiment of the Program

| | |
|---|---|
| Variable Life Insurance | The minimum death benefit of each insured may be |
| Policy | $250,000. The policy(ies) may cover a minimum of about |
| | 1000 lives; each admitted life may be subject to approval |
| | by the insurance company. The policy(ies) may qualify as |
| | a “life insurance contract” within the provisions of Section |
| | 7702 of the Internal Revenue Code or as a Modified |
| | Endowment Contract. |
| Mortality Assumptions | May be based upon actuarial tables. |
| Program Term | Approximately 60 years (until last insured dies or reaches |
| | maturity, age 100). |
| Macaulay Duration | Approximately 30-40 years. Defined as a measurement of |
| | the average time to receive all mortality income cash |
| | flows (adjusted for payments of premiums), weighted by |
| | each respective annual payout. |
| Minimum Death Benefit | $250,000,000 on 1,000 lives ($250,000 on each insured as |
| | long as the policy(ies) remains in force) |
| Total Death Benefits | $600,000,000-$800,000,000 per 1,000 lives (Estimated |
| | assuming a 7% annual net return). Results may depend |
| | upon average age of the insureds and the policy(ies) |
| | remaining in force. |
| Net Cash Flow | $525,000,000-$750,000,000 per 1,000 lives (Estimated |
| | assuming a 7% annual net return). Results may depend |
| | upon average age of the insureds, the structure of the |
| | policy(ies), and the policy(ies) remaining in force. |
| Program Purchase Price | $50,000,000-$80,000,000 (Approximate for MEC). |
| | Equivalent to an annual internal rate of return of |
| | approximately 6%-7% on the net cash flow. Results may |
| | depend upon average age of the insureds, and the |
| | policy(ies) remaining in force. |
| Premium Payments | The premiums may be sufficient to pay death benefits and |
| | create cash buildup (e.g., substantial cash buildup) within |
| | the policy(ies) (based upon assumed earnings assumptions |
| | within the separate account, and mortality assumptions). If |
| | the policy(ies) are structured as fully qualified life |
| | insurance, the proceeds from the sale may include the |
| | payment of premiums for year one and the present valued |
| | contribution to the NPO, and a guarantee of payment for |
| | year two. Following the initial premium payments, which |
| | may cover all premiums for the first five years, the |
| | periodic death benefits and additional pro rata earnings |
| | may be first applied to the payment of premiums due. |
| | These death benefits may cover all premiums due plus |
| | provide a positive cash flow until termination of the |
| | policy(ies), for example, in the 60^{th} year. The positive |
| | cash flow may form the basis for payments paid to the |
| | institution. If the policy(ies) are structured as a MEC, the |
| | proceeds from the sale may include the single first year |
| | premium and the present valued contribution to the NPO. |
| | Following the single premium payment, the periodic death |
| | benefits and additional pro rata earnings may form the |
| | basis for annual cash flows paid to the institution. |
| | Premiums in the variable life policy(ies) may not be |
| | guaranteed and may be subject to change according to |
| | investment experience within the policy. |
| Early Redemption | The program may be non-callable because the insurance |
| | policy(ies) may be non-callable by the insurance |
| | company. |
| Ownership | The NPO may be the owner/beneficiary of the policy(ies) |
| | through an established trust or other Special Purpose |
| | Vehicle (“SPV”) that is secured. The NPO, at closing, |
| | may convey all rights and benefits to net cash flow, and/or |
| | other rights and benefits to the capital assets contained |
| | within the policy(ies) to the institutional purchaser, for |
| | example, by a contract, trust, and/or security. The |
| | insurance policy(ies) may be non-cancelable so long as |
| | positive cash value is maintained. The institution may |
| | demand cancellation and/or distribution of assets, for |
| | example, at any time. The institution may hold the |
| | contract, the trust, and/or the security, or sell it in whole or |
| | in part at its discretion. |
| Separate Account | The cash values of the policy(ies) may be funded by a |
| | separate account of the life insurance company and may |
| | not be subject to claims of its creditors. The separate |
| | account may contain investment managers and/or assets |
| | approved by the life insurance company. Such funds may |
| | be moved among sub accounts of the separate account, for |
| | example, without incurring a tax liability on behalf of the |
| | institution buyer. As a result, investment strategies such as |
| | dollar cost averaging, asset allocation, and other |
| | rebalancing can be achieved with a maximum of |
| | flexibility and without the burden of expense and taxation |
| | as these events may occur. |
| Assumed Internal Return | 7.00% net. Internal return assumption can be varied. For |
| Within the Policy(ies) | illustrative purposes, a 7% net return over the lifetime of |
| | the program is assumed. |
| Net Cash Flow Income | May be treated as taxable. |
| Policy Loans | The investor may take out periodic policy loans, for |
| | example, for any number up to 100% (e.g., up to 90%) of |
| | the accumulated and unencumbered cash value. Upon the |
| | event of a policy loan, the insurance company may move |
| | the indicated amount to a loan guarantee account that may |
| | not be subject to market risk. Specific provisions |
| | regarding this aspect of the policy(ies) may be subject to |
| | the provisions as outlined in the life insurance policy(ies). |
| Cash Value | The accumulated cash value of the policy(ies) may vary to |
| | reflect the investment performance of the fund |
| | manager(s). The face amount (e.g., $250,000,000 per |
| | 1,000 lives) may be maintained at all times provided that |
| | positive cash value is maintained during the program |
| | period (e.g., approximately 60 years). If the investment |
| | experience is sufficiently positive, the death benefit may |
| | be adjusted upward, reflecting that investment experience. |
| | If negative, the death benefit may be adjusted downward, |
| | for example, not below the face amount of the original |
| | program (e.g., $250,000,000). |
| Transferability | The program may be, in whole or in part, transferable. |
| Servicing | The insurance company may provide for mortality |
| | tracking and other policy administration. |
| Accounting Procedure | Institutions (e.g., financial institutions) may account for |
| | this transaction as a purchase of cash flows. The benefits |
| | to the institutions may not be marked-to-market based |
| | upon the value of the underlying securities in the separate |
| | account. The institutions may book the benefits at |
| | purchase price. Based on the anticipated earnings rate at |
| | time of purchase, the institutions may credit interest at the |
| | purchase rate each year, subtract actual cash distributions, |
| | and add the net amount to the previous year's booked |
| | value. The asset may be booked on an accrual basis. |
| Off-Shore Variable Life | The insurance carrier may provide a list of external |
| Insurance Policy Options | managers that may allow the program purchaser a broad |
| | range of investment options. The program purchaser may |
| | be in a position to influence investment performance by |
| | recommending approved asset managers that meet its |
| | investment criteria. The program may include features that |
| | positively impact potential returns and minimize frictional |
| | costs. These may include: |

| | |
|---|---|
| | The insurance carrier may be a non-US carrier that |
| | enjoys the benefits of lower levels of taxation. This |
| | allows it to develop products with greater flexibility |
| | and lower costs. |
| | Sub account options may include a broad spectrum of |
| | asset managers and strategies that may not be |
| | available with insurance companies that retain all asset |
| | management internally. |
| Benefits | Investment diversification and flexibility (unique to |
| | variable life insurance policy); |
| | Separate account is not subject to claims of general |
| | creditors in the event of a default by the carrier; |
| | Flexible investment options available in the separate |
| | account; |
| | Dividends, capital gains and interest generated in the |
| | separate account are not taxable; |
| | Sale of one asset within the separate account and |
| | purchase of another is not a taxable event; |
| | Policy loans can be taken out for up to 90% (or more |
| | or less) of the accumulated cash value and |
| | withdrawals are permitted; |
| | Asset is non-callable; |
| | Asset does not have to be marked-to-market; and/or |
| | Asset can be parsed or transferred to another owner at |
| | the option of the holder. |

### Another Embodiment of the Program

| | |
|---|---|
| Variable Life Insurance | The standard minimum death benefit of each insured may |
| Policy | be $250,000. The policy(ies) may cover a minimum of |
| | 1000 lives; each admitted life may be subject to approval |
| | by the insurance company. The Policy(ies) may qualify as |
| | a “life insurance contract” within the provisions of Section |
| | 7702 of the Internal Revenue Code or as a Modified |
| | Endowment Contract. |
| Mortality Assumptions | May be based upon actuarial tables. |
| Policy Term | Approximately 60 years (e.g., until last insured dies or |
| | reaches maturity, age 100). |
| Macaulay Duration | 30-40 years (approximate). Defined as a measurement of |
| | the average time to receive all mortality income cash |
| | flows (adjusted for payments of premiums), weighted by |
| | each respective annual payout. |
| Minimum Death Benefit | $250,000,000 on 1000 lives ($250,000 on each insured as |
| | long as the Policy(ies) remains in force). |
| Total Death Benefits | $600,000,000-$900,000,000 per 1000 lives (estimated |
| | assuming a 7.00% annual net return in the separate |
| | account). Results may depend upon average age of the |
| | insureds and the Policy remaining in force. |
| Net Cash Flow | $550,000,000-$850,000,000 per 1000 lives (estimated |
| | assuming a 7.00% annual net return in the separate |
| | account). Results may depend upon average age of the |
| | insureds, the structure of the Policy, and the Policy |
| | remaining in force. |
| Program Purchase Price | $50,000,000-$80,000,000 (approximate for MEC). |
| | Determined by a net present value (“NPV”) of 6.00% on |
| | the cash flows from the projected death benefits. Results |
| | may depend upon average age of the insureds and the |
| | Policy remaining in force. |
| Premium Payments | The premiums may be sufficient to pay death benefits and |
| | create cash buildup within the Policy(ies) (based upon |
| | assumed underlying Separate Account earnings and |
| | mortality assumptions). Assuming the Policies are |
| | structured as a MEC, the proceeds from the sale may |
| | include the single first year premium and the present |
| | valued contribution to the NPO. Following the single |
| | premium payment, the periodic death benefits and |
| | additional pro rata earnings may form the basis for annual |
| | cash flows paid to the institution. |
| Early Redemption | The Program may be non-callable because the insurance |
| | Policy(ies) may be non-callable by the insurance |
| | company. |
| Investment Loan | The NPO, as owner/beneficiary of the Policy(ies) may |
| Ownership | structure a secured borrowing arrangement with the |
| | Lender contributing the Policy(ies) to a Trust (e.g., |
| | QSPE). The Lender may have as collateral the assets of |
| | the Policy(ies), which may include the guarantee of |
| | mortality payments from the insurance company that the |
| | Policy(ies) contain. Upon receipt of death benefits from |
| | the insurance company, the trust may disburse the funds to |
| | the Lender. The Lender may have a call option to acquire |
| | the Policy(ies) from the Trust (“Option”). The Lender |
| | may exercise the Option at any time by giving notice to |
| | the trustee of the Trust. The strike price of the Option |
| | may be the original issue price of the Note reduced by the |
| | outstanding principal balance plus any accrued but unpaid |
| | interest on the Note plus an additional cash payment (e.g., |
| | approximately $50,000). The Lender may designate the |
| | Investment Advisor who, in turn, may determine the |
| | investment allocation of the funds with the insurance |
| | policy. On a periodic basis, the Lender can change the |
| | designated Investment Advisor but may be unable to |
| | direct specific investment decisions, including allocation |
| | of investments by asset type. The Lender may also have |
| | the right to sell and/or assign its Note at its discretion. The |
| | insurance policy(ies) may be non-cancelable as long as |
| | there is sufficient cash value to pay the costs of the |
| | Policy(ies). In addition, separate from the trust, the Lender |
| | may enter into a consulting and advisory agreement with |
| | the insurance company regarding the investments in the |
| | Separate Account. |
| Separate Account | The cash values of the Policy(ies) may be funded by a |
| | Separate Account of the life insurance company and may |
| | not be subject to claims of its creditors. |
| | The Separate Account may contain investment assets |
| | approved by the life insurance company. Such funds may |
| | be moved among sub accounts of the Separate Account |
| | without incurring a tax liability on behalf of the |
| | institutional Lender. As a result, investment strategies |
| | such as dollar cost averaging, asset allocation, and other |
| | rebalancing can be achieved with a maximum of |
| | flexibility and without the burden of expense and taxation |
| | as these events may occur. |
| Assumed Internal Return | 7.00% net. (Internal return assumptions can be varied. For |
| Within the Policy | example, a 7.00% net return over the lifetime of the |
| | Program may be assumed.) |
| Net Cash Flow Income | Currently being treated as taxable. |
| Cash Value | The accumulated cash value of the Policy(ies) may vary to |
| | reflect the investment performance of the fund |
| | manager(s). The face amount ($250,000,000 per 1000 |
| | lives) may be maintained at all times provided that |
| | sufficient cash value is maintained pay the insurance |
| | company charges during the Policy contract period (e.g., |
| | approximately 60 years). If the investment experience is |
| | sufficiently positive the death benefit may be adjusted |
| | upward, reflecting that investment experience. |
| Transferability | The Note may be fully transferable. |
| Servicing | The insurance company may provide for mortality |
| | tracking and other Policy administration as required. |
| Accounting Procedure | The Lender may be permitted to account for this |
| | transaction as an “available for sale investment” under |
| | FASB 140 at full purchase price. The Program may not |
| | have to be marked-to-market based upon the value of the |
| | underlying securities in the Separate Account. |
| | The investment may be classified by the Lender as an |
| | “available for sale investment” under FASB 140 at full |
| | purchase price. The value of the investment each year may |
| | be determined by fair value. Fair value may be the NPV of |
| | the projected future cash flows barring any impairment, |
| | temporary or permanent. Examples of permanent |
| | impairments may include the following: (1) a significant |
| | increase in mortality earlier than expected resulting in |
| | substantially higher than expected death benefits; (2) a |
| | catastrophic loss in the underlying Separate Account that |
| | would reduce projected future payments above the face |
| | value; (3) failure of the insurance company to pay death |
| | benefits. |
| | The Lender may book the Investment at the purchase |
| | price. Based upon the anticipated earnings rate at time of |
| | purchase, the Lender may credit interest at the purchase |
| | rate (e.g., 6.00%) each year, subtract actual cash |
| | distributions, and add the net amount to the previous |
| | year's booked value. The investment may be booked on |
| | an accrual basis. |
| Variable Life Insurance | The insurance carrier may provide a list of external |
| Policy Options | managers to allow the Lender a broad range of investment |
| | options. The Lender may designate the Investment |
| | Advisor who, in turn, may determine the investment |
| | allocation of the funds with the insurance policy. On a |
| | periodic basis, the Lender can change the designated |
| | Investment Advisor but may be unable to direct specific |
| | investment decisions, including allocation of investments |
| | by asset type. The Lender may be in a position to |
| | influence investment performance by recommending asset |
| | managers and strategies through an advisory agreement |
| | with the insurance company that meet its investment |
| | criteria. The Policy(ies) may include features that |
| | positively impact potential returns and minimize the |
| | frictional costs typically associated with other policies. |
| | They include: |

| | The insurance carrier may be a non-US carrier and |
|---|---|
| | thus enjoys the benefits of lower levels of taxation. |
| | This may allow it to develop products with greater |
| | flexibility and lower costs. |
| | Sub account options may include a broad spectrum of |
| | asset managers and strategies that may not be |
| | available with insurance companies that retain all asset |
| | management internally. |
| Summary of Benefits | Investment Diversification and flexibility, unique to a |
| | Variable Life Insurance Policy. |
| | Separate Account is not subject to claims of general |
| | creditors in the unlikely event of a default by the |
| | carrier. |
| | Security of collateral value. Approximately 77% to |
| | 85% collateralization on day one with 100%+ |
| | collateralization within 2 to 4 years depending upon |
| | returns within the Separate Account. Immediate return |
| | of collateral upon default vs. long term litigation upon |
| | failure of a corporate bond. Most corporations that |
| | issue bonds have an average leverage of 2:1 debt vs. |
| | equity. That is, collateralization of 33%. Such |
| | collateral is not liquid and may consist of plant, |
| | equipment, good will, etc. If there is a problem with |
| | the company, recovery is through the courts (usually |
| | in bankruptcy), behind other creditors, along with |
| | similar creditors led by the strongest. Recovery could |
| | take several years. Liquidation of the underlying |
| | assets under normal circumstances that is not |
| | significantly slower than liquidation of securities. |
| | Favorable accounting treatment. |
| | Duration and cash flows match long-term liabilities |
| | (e.g., retirement benefits, etc.) |
| | Flexible investment options available in the Separate |
| | Account. |
| | The Lender may designate the Investment Advisor |
| | who, in turn, specifically determines the investment |
| | allocation of the funds with the insurance policy. |
| | Dividends, capital gains and interest generated in the |
| | Separate Account are not taxable. |
| | Sale of one asset within the Separate Account and |
| | purchase of another is not a taxable event. |
| | Asset is non-callable. |
| | Asset does not have to be marked-to-market against |
| | value of the Separate Account. |
| | Asset can be parsed or transferred to another owner at |
| | the option of the holder. |

Presently, institutions need:

long-term duration assets;

asset mix that provides predictability and security of cash flows;

security of collateral value;

credit enhancement of portfolio;

duration and cash flow match long-term liabilities (e.g. retirement benefits, etc.);

non-callable asset;

no reinvestment decisions exterior to the asset that result in a reallocation of portfolio funds;

flexible investment parameters for funds within the asset;

the lender may designate the investment advisor who, in turn, specifically determines the investment allocation of the funds within the insurance policy(ies);

favorable accounting treatment;

favorable tax treatment; and/or

diversification in the overall portfolio.

In comparison, one exemplary embodiment of a structured financial asset may include:

Long term duration (e.g., 30-40 years Macauley).

Asset mix may be a combination of invested securities and expected mortality payments based upon established actuarial tables/formula. Cash distributions may be based upon and timed by mortality payments. As long as the policy(ies) remains in force, a rated insurance company may guarantee the face amount. The mortality payments part of the cash flow may include a safety component independent from the securities in the separate account.

Approximately 75%-95% (or more or less) collateralization on day one with 100% (or more or less) collateralization from the second year forward. A call option that provides for the immediate return of collateral upon request. (By comparison, long term litigation upon failure of a corporate bond. Most corporations that issue bonds have an average leverage of 2:1 debt vs. equity, i.e., a collateralization of 33%. Such collateral is not liquid and may consist of plant, equipment, good will, etc. If there is a problem with the company, recovery is through the courts (usually in bankruptcy), behind other creditors, along with similar creditors led by the strongest. Recovery could take several years.) Liquidation of the underlying assets under normal circumstances that is not significantly slower than liquidation of securities.

The mortality payments from the policy(ies) may be guaranteed by the creditworthiness of the insurance company. The insurance company may be considered investment grade with an expected AA rating. The performance of the underlying Separate Account can significantly increase the mortality payments from the minimum face value. Increased mortality payments may continue to have the same creditworthiness guarantee from the insurance company based upon the value of the underlying separate account. Thus, there may be an AA credit “wrapper” around the securities in the separate account. (For example, as long as there is sufficient cash value in the separate account to keep the policy(ies) in force.)

Cash flow curve and duration may match long-term liability issues.

The program may include no callable features (preserving duration).

Investment decisions may be made within the program. The portfolio manager does not have to make reinvestment decisions that create a reallocation of funds in the entire portfolio. (For example, for institutions that do not have large investment management operations, the cost of management of funds in the policy(ies) may be lower than creating fixed overhead costs within the institution).

The program may provide for maximum funding of the policy(ies) to create significant and higher than standard asset buildup within the policy(ies). Funds can be moved and reallocated within the policy(ies). The buyer and/or the lender may have an investment advisor and consulting agreement with the insurance company.

The lender may designate the investment advisor who, in turn, may determine the investment allocation of the funds with the insurance policy. On a periodic basis, the lender may change the designated investment advisor and/or may be unable to direct specific investment decisions, including allocation of investments by asset type.

The program has favorable accounting treatment: the buyers and/or the lenders may account for the transaction as an “available for sale investment” under FASB 140 at full purchase price. The program may not be marked-to-market based on the value of the underlying securities in the separate account. The rights and/or benefits may be booked and carried initially at purchase price; the book value may be increased each year using an accrual formula based upon assumed rates of return less actual cash distributions (the asset may not be “marked to market”). and/or

Capital gains, dividends and/or interest income may accumulate tax free within the policy(ies).

In comparison, features of securities include:

there are few if any long duration assets available (e.g., 100 year bonds have a Macauley of 12-16 years);

portfolio manager creates asset mix and no corporate asset is as certain or predictable as mortality;

recovery of funds under adverse conditions is time consuming, expensive and uncertain. Liquidation under normal circumstances is minimally faster;

there is no credit enhancement beyond the inherent rating or non-rating of the individual security. There is no overall portfolio enhancement;

long-term liabilities are not easily matched with a single security purchase;

most long-term income securities are callable or subject to refunding;

require constant reallocation and reinvestment decisions affecting the entire portfolio;

funds can be moved and reallocated;

are “marked to market” reflecting immediate decreases or increases in valuation (In the event of a decrease, the portfolio manager is immediately judged on the loss.);

tax treatment is dependent upon the tax status of the institutional buyer and/or lender; and

are generally not part of the required diversification.

FIG. 1 illustrates one exemplary implementation of a method 100 for raising funds. The method 100 may identify insurable interests associated with a NPO. The method 100 may request authorization for the NPO to insure the insurable interests. The method 100 may receive authorization for the NPO to insure the insurable interests. The method 100 may take out a life insurance policy (e.g., a group life insurance policy) or a plurality of life insurance policies (e.g., a plurality of individual life insurance policies) on the insurable interests associated with the NPO. The method 100 may name the NPO as beneficiary of the life insurance policy(ies). The method 100 may group (e.g., selectively pool) the plurality of life insurance policies. The method 100 may raise funds for the NPO from the life insurance on the insurable interests.

The life insurance policy(ies) may produce a cash flow over a term of the life insurance policy(ies), in part or in whole, from mortality payments. The method 100 may hold the life insurance policy(ies) in a vehicle, for example, that is bankruptcy remote. The method 100 may invest premium payments of the life insurance policy(ies), through an account (e.g., a separate account), in assets to produce the cash flow over the term of the life insurance policy(ies). The method 100 may transfer part or all of (i) the cash flow and/or other rights and benefits from the life insurance policy(ies), for example, through a contract, a trust, and/or a security, and/or (ii) the holding vehicle for the life insurance policy(ies) to at least a second organization to raise funds for the NPO and/or the second organization.

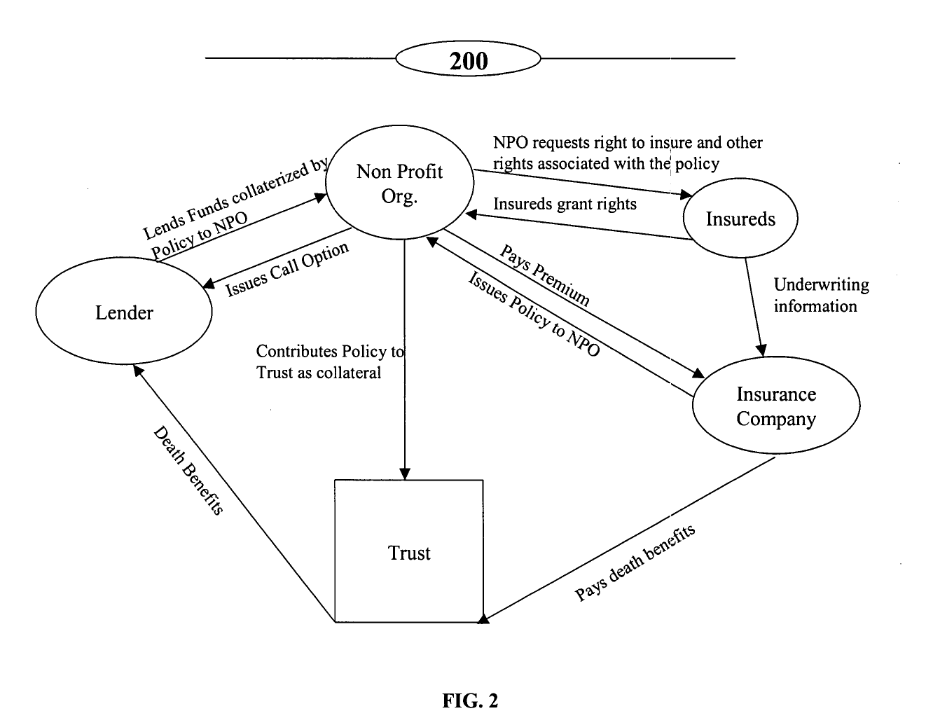

FIG. 2 illustrates one exemplary implementation of a method 200 for raising funds. A first organization as exclusive agent for an NPO may arrange for a loan by an institutional investor (e.g., the “Lender”) secured, for example, by a variable life insurance contract. An NPO may obtain a group policy and/or a plurality of individual policies, for example, insuring the lives of approximately 1000 individuals (or more or less). The Lender may lend funds to the NPO on a non-recourse basis, evidenced by a promissory note (the “Note”) secured only by the Policy. The NPO may establish a trust to hold the Policy (the “Trust”). The trustee of the Trust may hold the Policy, and shall distribute to the Lender all death benefits and other net cash flows the Trust receives with respect to the Policy (the “Policy Benefits”) to the extent required to repay the Note.

Each Policy may insure approximately 1,000 or more lives, selected consistent with an actuarial matrix intended to generate Policy Benefits sufficient to repay the Note. Each Trust may hold a Policy (or policies) on behalf of a single Lender and NPO. There may be no pooling of income among other lenders or other NPOs, and there may exist no agreements to share of any gains or risk of loss with respect to such Policy. Each transaction implemented under the Program may be a distinct separate unit. All of the costs and expenses incurred by the NPO (e.g., insurance premiums, administrative and set up charges, fees paid to Mission Capital) may be borne by the NPO.

Under the Program, the Insureds may consent to be insured, for example, for approximately $250,000 each. The Insureds agree to permit the respective NPO to take out an appropriate Policy on their lives and to hold or dispose of it in whole or in part as the NPO deems appropriate. The life insurance policy may be a variable universal life policy that may qualify as an insurance contract. The insurance company may guarantee death benefits as long as the policy remains in force. Death benefits may consist of the standard death benefit of $250,000 (more or less). If investment performance is sufficiently positive, the proceeds may exceed the minimum death benefits of $250,000. The insurance company may assume responsibility for mortality tracking and other policy administration as required.

The Insureds may assign these rights and the benefits associated with it to the NPO. As such, the NPO may have the sole responsibility for paying the premiums on the Policy. The Policies may be structured as a single premium modified endowment contract. Upon receipt of the loan proceeds from the Lender, the NPO may contribute the Policy to the Trust. The Trust may distribute all Policy Benefits it receives to the Lender, to the extent required to repay the Note. The Note may bear interest at a negotiated rate (e.g., between 6 and 8 percent), compounded annually, and may have a yield maintenance provision applicable if the NPO seeks to pay off the Note before maturity entitling the Lender to an internal rate of return, for example, of 18%.

The NPO may also assign to the Lender the right to direct the Trustee to take certain actions with respect to the Policy. For example, the Lender may require the Trustee to cancel the policy and distribute all assets contained within it to the trustee at any time. The Lender may also sell or assign its beneficial rights to the Policy Benefits in whole or in part at its discretion. For example, once the Program is implemented, the Lender and the NPO may be the sole beneficiaries of the Trust.

The Lender may have a call option to acquire the Policy from the Trust (“Option”). The Lender can exercise the Option at any time by giving notice to the trustee of the Trust. The strike price of the Option may be the original amount of the Note reduced by the outstanding principal balance plus any accrued but unpaid interest due under the Note.

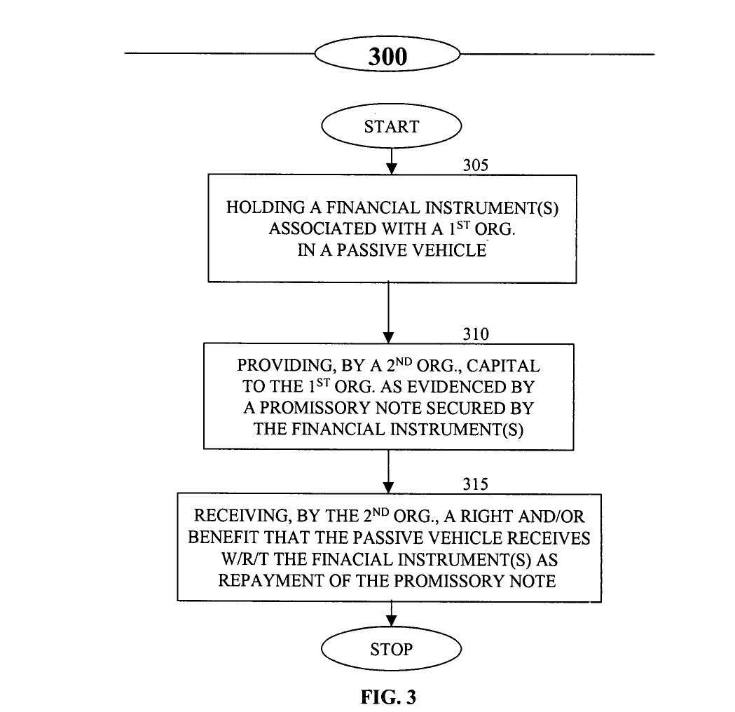

FIG. 3 illustrates one exemplary implementation of a method 300, for example, for raising funds. In block 305, the method 300 holds a financial instrument of a first organization in a passive vehicle. In block 310, the method 300 provides, by a second organization, capital to the first organization as evidenced by a promissory note secured by the financial instrument. In block 315, the method 300 receives, by the second organization, a right and/or a benefit that the passive vehicle receives with respect to the financial instrument as repayment of the promissory note.

The right and/or the benefit may include (1) canceling the financial instrument, (2) distributing all assets contained within the passive vehicle, (3) transferring a right and/or a benefit from the financial instrument at any time and/or (4) a call option to acquire the financial instrument from the passive vehicle.

The passive vehicle may be a trust such as, for example, a QSPE. The passive vehicle may hold the financial instrument on behalf of the first organization and/or the second organization. The first organization may be a non-profit organization, whereas the second organization may be a lender(s), a buyer(s) and/or an individual(s).

The financial instrument may include one or more insurance policies, for example, insuring the lives of a plurality of individuals associated with the first organization. The one or more insurance policies may be structured as a single premium modified endowment contract. The financial instrument may also be a variable universal life insurance. The first organization may be responsible (e.g., solely responsible) for the premiums of the financial instrument (e.g., the one or more insurance policies).

The plurality of individuals may be selected consistent with an actuarial matrix designed to generate sufficient death benefits and/or other net cash flows to repay the promissory note. Also, the second organization, upon the transfer of the financial instrument by the first organization to the passive vehicle, may have an investment classified as an “available for sale investment” under FASB 140 at the full purchase price of the second organization.

The structure of one or more of the programs described above may be classified as a transfer of collateral and a secured nonrecourse borrowing by a first organization (e.g., an NPO) and a secured borrowing arrangement under FASB 140 by a second organization (e.g., a lender).

A machine-readable medium may include encoded information, which when read and executed by a machine causes, for example, the method 100, the method 200, the method 300 and/or described embodiments. The machine-readable medium may store programmable parameters and may also store information including executable instructions, non-programmable parameters, and/or other data. The machine-readable medium may comprise read-only memory (ROM), random-access memory (RAM), nonvolatile memory, an optical disk, a magnetic tape, and/or magnetic disk. The. machine-readable medium may further include, for example, a carrier wave modulated, or otherwise manipulated, to convey instructions that can be read, demodulated/decoded and executed by the machine (e.g., a computer). The machine may comprise one or more microprocessors, microcontrollers, and/or other arrays of logic elements.

The foregoing presentation of the described embodiments is provided to enable any person skilled in the art to make or use the present invention. Various modifications to these embodiments are possible, and the generic principles presented herein may be applied to other embodiments as well. As such, the present invention is not intended to be limited to the embodiments shown above, any particular sequence of acts, and/or any particular configuration of hardware but rather is to be accorded the widest scope consistent with the principles and novel features disclosed in any fashion herein.

What is claimed is:

1. A method comprising:
holding a financial instrument of a first organization in a passive vehicle;
providing, by a second organization, capital to the first organization as evidenced by a promissory note secured by the financial instrument; and
receiving, by the second organization, a right and/or a benefit that the passive vehicle receives with respect to the financial instrument as repayment of the promissory note.

2. The method of claim 1, wherein the passive vehicle holds the financial instrument on behalf of the first organization and the second organization.

3. The method of claim 1, wherein the right and/or the benefit includes canceling the financial instrument.

4. The method of claim 1, wherein the right and/or the benefit includes distributing all assets contained within the passive vehicle.

5. The method of claim 1, wherein the right and/or the benefit includes transferring a right and/or a benefit from the financial instrument at any time.

6. The method of claim 1, wherein the right and/or the benefit includes a call option to acquire the financial instrument from the passive vehicle.

7. The method of claim 1, wherein the first organization is a non-profit organization.

8. The method of claim 1, wherein the second organization includes a lender.

9. The method of claim 1, wherein the financial instrument includes one or more insurance policies.

10. The method of claim 9, wherein the one or more insurance policies insures the lives of a plurality of individuals associated with the first organization.

11. The method of claim 10, wherein the plurality of individuals are selected consistent with an actuarial matrix.

12. The method of claim 11, wherein the first organization is solely responsible for the premiums of the one or more insurance policies.

13. The method of claim 9, wherein the one or more insurance policies is structured as a single premium modified endowment contract.

14. The method of claim 1, wherein the financial instrument includes variable universal life insurance.

15. The method of claim 1, wherein the passive vehicle includes a trust.

16. The method of claim 1, wherein the passive vehicle includes a Qualifying Special Purpose Entity.

17. The method of claim 1, wherein the second organization, upon the transfer of the financial instrument by the first organization to the passive vehicle, has an investment classified as an “available for sale investment” under FASB 140 at the full purchase price of the second organization.

18. A method comprising:
taking out one or more policies insuring the lives of a plurality of individuals associated with a non-profit organization;
receiving funds as evidenced by a promissory note secured by the one or more policies; and
repaying the promissory note by transferring one or more benefits and/or rights from the one or more policies.

19. A method comprising:
taking out life insurance on insurable interests of a first organization and naming the first organization as beneficiary of the life insurance;
raisings funds for the first organization by at least borrowing funds from a second organization as evidenced by a promissory note secured by the life insurance; and
transferring one or more rights and/or benefits from the life insurance on the insurable interests to the second organization.

20. A method comprising:
taking out a financial instrument on insurable interests of a first organization and naming the first organization as beneficiary of the financial instrument;
providing, by a second organization, capital to the first organization as evidenced by a promissory note secured by the financial instrument;
transferring the financial instrument of the first organization into a passive vehicle for the benefit of the first organization and the second organization; and
receiving, by the second organization, a right and/or a benefit that the passive vehicle receives with respect to the financial instrument as repayment of the promissory note.

21. The method of claim 20, further comprising
providing a call option to the second organization to acquire the financial instrument from the passive vehicle.

22. The method of claim 20, wherein the first organization is solely responsible for the premiums of the financial instrument.

23. The method of claim 20, wherein the passive vehicle is a Qualifying Special Purpose Entity.

24. The method of claim 20, wherein the second organization, upon the transfer of the financial instrument by the first organization to the passive vehicle, has an investment classified as an “available for sale investment” under FASB 140.
